(19) United States
(12) Patent Application Publication
(10) Pub. No.: US 2006/0067860 A1
(43) Pub. Date: Mar. 30, 2006

(54) Construction for an engine exhaust system component

(76) Inventors: Arthur E. Faircloth JR., Kellogg, IA (US); Matthew P. Fortuna, Eagan, MN (US); John I. Belisle, Hampton, MN (US); Allan T. Hovda, Savage, MN (US); Josh J. Kundert, Burnsville, MN (US)

Correspondence Address: MERCHANT & GOULD PC, P.O. BOX 2903, MINNEAPOLIS, MN, 55402-0903, US

(21) Appl. No.: 11/223,460

(22) Filed: Sep. 8, 2005

Related U.S. Application Data
(60) Provisional application No. 60/608,422, filed on Sep. 8, 2004.
(60) Provisional application No. 60/608,266, filed on Sep. 8, 2004.
(60) Provisional application No. 60/626,823, filed on Nov. 9, 2004.
(60) Provisional application No. 60/662,904, filed on Mar. 17, 2005.

(51) Int. Cl. B01D 50/00; F16L 9/18

(52) U.S. Cl. 422/171; 138/109; 138/112; 138/114; 138/148; 138/149; 422/177; 422/179

(57) ABSTRACT

The present disclosure relates to a double-wall construction for an engine exhaust conduit. The construction includes an inner conduit and an outer conduit surrounding the inner conduit. An insulating annular gap is defined between the inner and outer conduits. A spacer structure maintains the gap between the inner and outer conduits. The spacer structure can be unitary with at one of the inner and outer conduits.

This application claims the benefit of U.S. Provisional Patent Application Ser. No. 60/608,422 filed Sep. 8, 2004, U.S. Provisional Patent Application Ser. No. 60/608,266 filed Sep. 8, 2004, U.S. Provisional Patent Application Ser. No. 60/626,823 filed Nov. 9, 2004 and U.S. Provisional Patent Application Ser. No. 60/662,904 filed Mar. 17, 2005, which applications are hereby incorporated by reference in their entirety.

### TECHNICAL FIELD

The present invention relates generally to exhaust system components for housing exhaust aftertreatment devices having cores such as catalytic converters or diesel particulate filters.

### BACKGROUND

To reduce air pollution, engine exhaust emissions standards have become increasingly more stringent. Aftertreatment devices have been developed to satisfy these increasingly stringent standards. For example, catalytic converters have been used to reduce the concentration of pollutant gases (e.g., hydrocarbons, carbon monoxide, nitric oxide, etc.) exhausted by engines. U.S. Pat. No. 5,355,973, which is hereby incorporated by reference, discloses an example catalytic converter. With respect to diesel engines, diesel particulate filters (DPF's) have been used to reduce the concentration of particulate matter (e.g., soot) in the exhaust stream. U.S. Pat. No. 4,851,015, which is hereby incorporated by reference, discloses an example diesel particulate filter. Other example types of aftertreatment devices include lean NOx catalyst devices, selective catalytic reduction (SCR) catalyst devices, lean NOx traps, or other device for removing for removing pollutants from engine exhaust streams.

At times, it is recommended to service or replace aftertreatment devices. To facilitate servicing and/or replacement, aftertreatment devices are often clamped into an exhaust system as separate units. For example, clamps can be provided at flange interfaces located adjacent opposite ends of the aftertreatment devices. By removing the end clamps, a given aftertreatment device can be removed from its corresponding exhaust system for servicing or replacement.

Engine exhaust can have temperatures that exceed 600 degrees Celsius. It is sometimes desirable for engine exhaust components to maintain outer skin temperatures that are substantially lower than the temperature of the exhaust passing through the components. To maintain relatively low outer skin temperatures, it is known to wrap insulation about the engine exhaust components, and to enclose the insulation within an outer protective skin/shield.

### SUMMARY

One aspect of the present disclosure relates to a double-wall construction configuration for an engine exhaust system component. The double-wall construction includes an inner conduit, and outer conduit that surrounds the inner conduit, and a spacer that extends radially between the inner and outer conduits. In certain embodiments, the spacer is integral/unitary with one of the inner or outer conduits. In other embodiments, a flange is integral/unitary with one of the inner or outer conduits. In still other embodiments, a pilot portion is integral/unitary with one of the inner or outer conduits.

Another aspect of the present disclosure relates to an enhanced insulation configuration for an engine exhaust component.

A variety of other aspects of the invention are set forth in part in the description that follows, and in part will be apparent from the description, or may be learned by practicing the invention. The aspects of the invention relate to individual features as well as combinations of features. It is to be understood that both the foregoing general description and the following detailed description are exemplary and explanatory only and are not restrictive of the invention as claimed.

### BRIEF DESCRIPTION OF THE DRAWINGS

FIG. 1 is a cross sectional view of an exhaust system component having features that are examples of inventive aspects in accordance with the principles of the present disclosure, the arrangement is shown with the mid-section clamps not fully tightened;

FIG. 1A is an enlarged, detailed view of a first flange interface of the arrangement of FIG. 1;

FIG. 1B is an enlarged, detailed view of a second flange interface of the arrangement of FIG. 1;

FIG. 2 is a cross sectional view of the exhaust arrangement of FIG. 1 with the clamps fully tightened;

FIG. 2A is an enlarged, detailed view of the first flange interface of the arrangement of FIG. 2;

FIG. 2B is an enlarged, detailed view of the second flange interface of the arrangement of FIG. 2;

FIG. 3 illustrates an example clamp adapted for use at the first and second flange interfaces of the exhaust arrangement of FIG. 1;

FIG. 4 is a cross sectional view taken along section line 4-4 of FIG. 3;

FIG. 5 illustrates another exhaust system component having features that are examples of inventive aspects in accordance with the principles of the present disclosure;

FIG. 6 illustrates a further exhaust system component having features that are examples of inventive aspects in accordance with the principles of the present disclosure;

FIG. 7 illustrates an exhaust system insulation configuration having features that are examples of inventive aspects in accordance with the principles of the present disclosure;

FIG. 8 is a cross-sectional view of FIG. 7 taken along section line 8-8;

FIGS. 9 and 9A show an exhaust aftertreatment component with an alternative spacer configuration having features in accordance with the principles of the present disclosure.

FIG. 10 shows another exhaust aftertreatment component in accordance with the principles of the present disclosure;

FIG. 10A is an enlarged view of the upstream access joint of the exhaust aftertreatment component of FIG. 10; and

FIG. 10B is an enlarged view of the downstream access joint of the exhaust aftertreatment component of FIG. 10.

While the invention is amenable to various modifications and alternative forms, specifics thereof have been shown by way of example in the drawings and will be described in detail below. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION

In the following detailed description, references are made to the accompanying drawings that depict various embodiments in which the invention may be practiced. It is to be understood that other embodiments may be utilized, and structural and functional changes may be made without departing from the scope of the present invention.

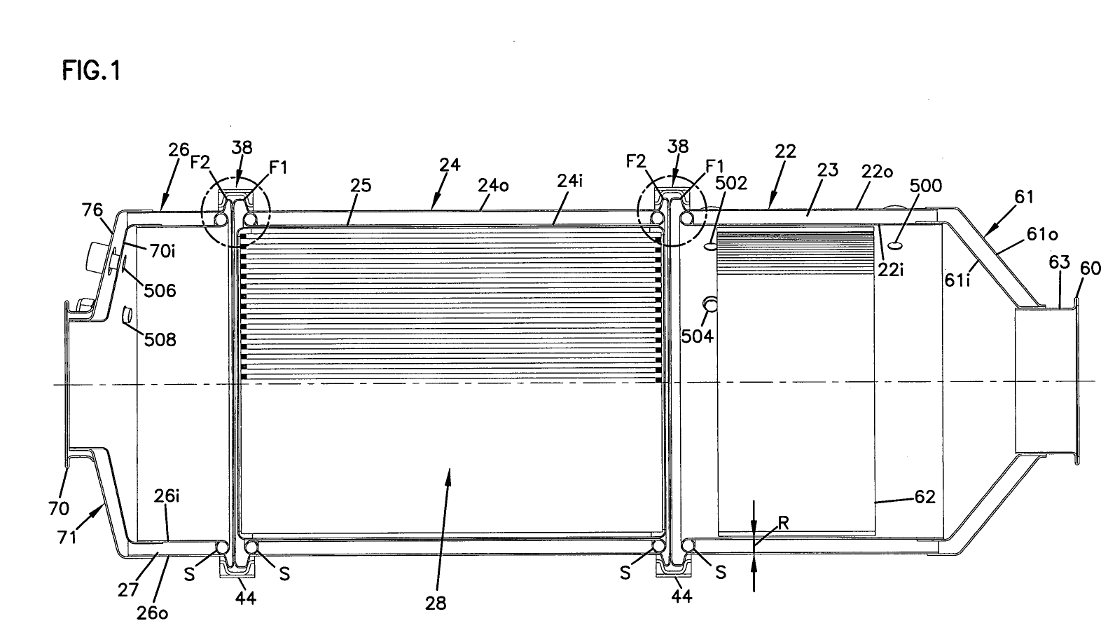

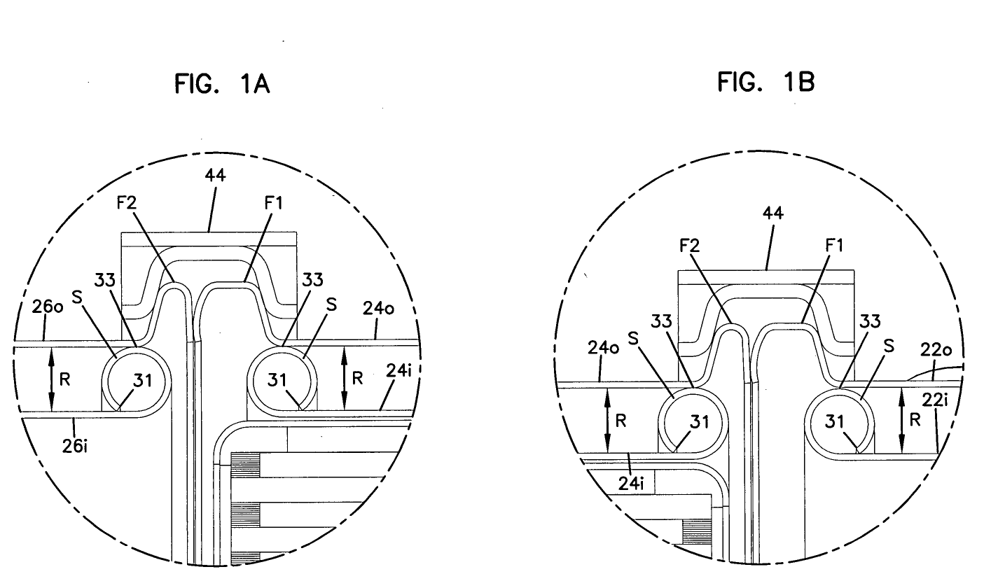

FIG. 1 illustrates an exhaust system arrangement including a first conduit 22, a second conduit 24, and a third conduit 26. The second conduit 24 is mounted between the first and third conduits 22, 26. An aftertreatment device 28 is mounted within the second conduit 24. Flange interfaces 38 are provided between the first and second conduits 22, 24 and between the second and third conduits 24, 26. Each of the flange interfaces 38 includes a first flange F1 and a second flange F2. Clamps 44 (e.g., v-band clamps) are provided at the flange interfaces 38 to secure the conduits 22, 24 and 26 together. The flanges F1, F2 assist in mechanically coupling the conduits 22, 24, 26 together, and in sealing the ends of the conduits.

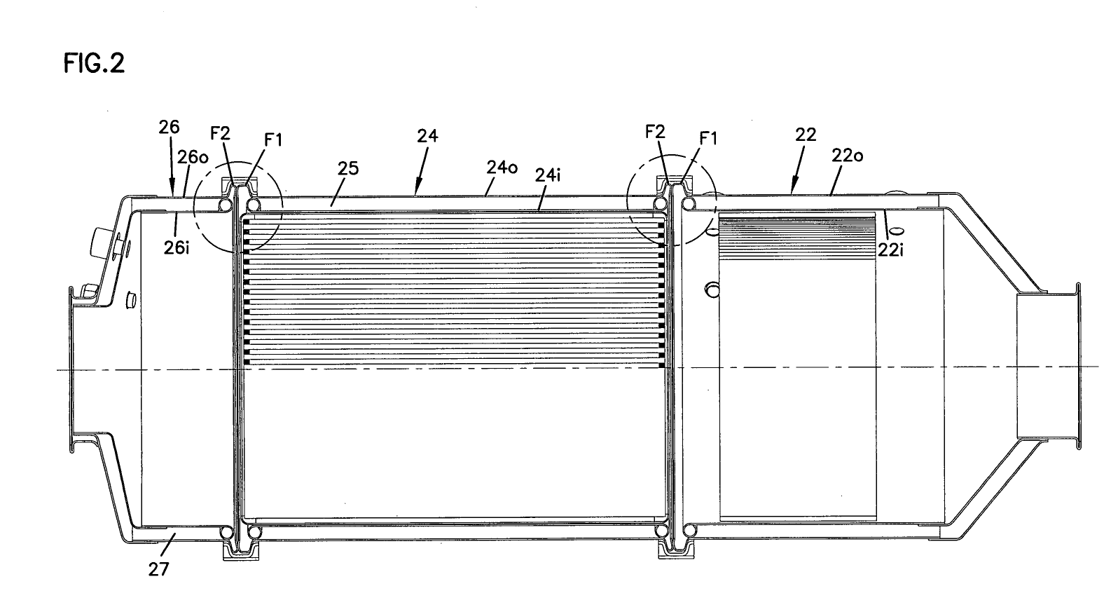

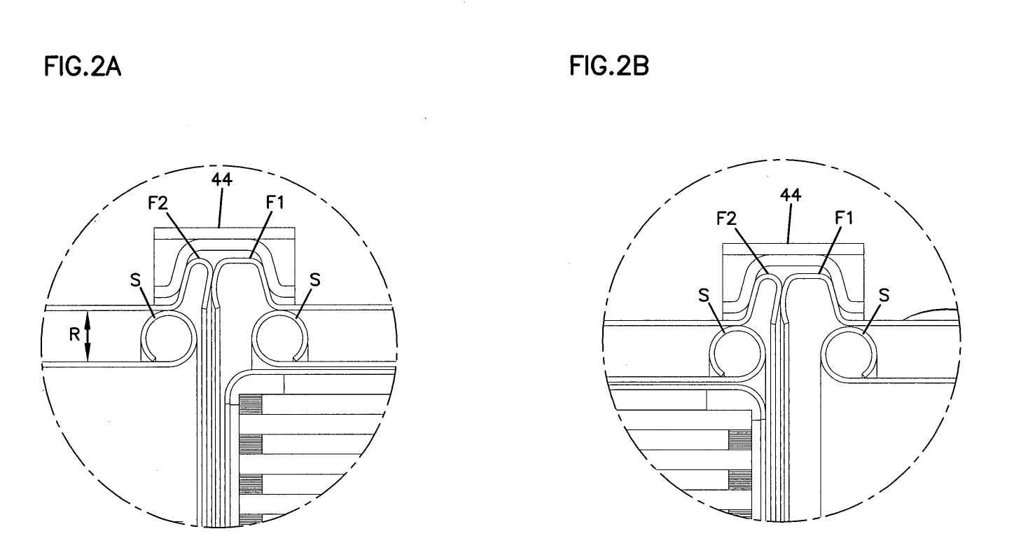

In assembling the system, the conduit 24 is positioned between the conduits 22,26, and the clamps 44 are loosely positioned at the flange interfaces 38 as shown at FIGS. 1, 1A and 1B. The clamps 44 are then tightened about the flange interfaces 38 as shown at FIGS. 2, 2A and 2B. When the clamps are tightened, the diameters of the clamps constrict and the flanges F1, F2 are compressed together to seal the ends of the conduits.

In the depicted embodiment of FIG. 1, the conduits 22, 24, and 26 are part of an exhaust aftertreatment component (e.g., an exhaust emissions reduction unit, muffler, or other exhaust system component). The conduit 22 forms an inlet section having a flanged end 60 adapted for connection to an inlet pipe, while the conduit 26 forms an outlet section having a flanged end 70 adapted for connection to an outlet pipe. The inlet section includes a diameter expander 61 while the outlet section includes a diameter reducer 71. A diesel oxidation catalyst 62 (i.e., a catalytic converter) is shown mounted within the conduit 22. The aftertreatment device 28 mounted within the conduit 24 is depicted as a diesel particulate filter. The flange interfaces 38 allow the diesel particulate filter to be easily removed for servicing (e.g., cleaning). The diameter expansion of the aftertreatment component provides some sound attenuation (e.g., muffling action). In alternative embodiments, additional structures for muffling sound (e.g., sonic chokes, resonating chambers, or other structures) can be incorporated into the component.

The conduit 22 has a double-wall construction. For example, conduit 22 includes an inner conduit wall 22i surrounded by an outer conduit wall 22o. An annular insulating space 23 is defined between the conduit walls 22i, 22o. The insulating space 23 can be filled with only air, or can be filled with an insulating material such as fiberglass, ceramic fiber or other materials that have effective thermal insulating properties. The diameter expander 61 of the conduit 22 also has a double-wall construction. As shown at FIG. 1, the double-wall construction of the diameter expander 61 includes inner and outer truncated conical walls 61i, 61o that respectively connect the upstream ends of the conduit walls 22i, 22o to a flanged pipe 63. The flanged pipe 63 defines the flanged end 60 of the conduit 22. The upstream end of the inner conduit wall 22i defines a spacer S that maintains the spacing between the inner and outer conduit walls 22i, 22o. The spacer S extends about the circumference of the inner conduit wall 22i and has a radial dimension R that extends between the inner and outer conduit walls 22i, 22o. The downstream end of the outer conduit wall 22o defines one of the flanges F1. The flange F1 is integral/unitary (i.e., formed as a single piece without any intermediate seams, joints or welds) with the outer conduit wall 22o.

The spacer S of the conduit 22 is formed by rolling or curling back the upstream end portion of the inner conduit wall 22i to form a structure having a generally round/circular cross-section as shown at FIG. 1B. The spacer S preferably extends about the entire circumference/perimeter of the conduit wall 22i. The upstream end portion of the conduit wall 22i is bent outwardly and rolled/curled back upon itself. In this way, the spacer S is integral/unitary (i.e., formed as a single piece without any intermediate seams, joints, or welds) with the main body of the inner wall 22i. An end 31 of the spacer S preferably engages the outer surface of the main body of the inner wall 22i. The outer wall 22o generally tangentially engages an outermost region 33 of the spacer S. In one embodiment, ring contact exists between the spacer S and the outer wall 22o. In certain embodiments, the outer conduit wall 22o can be secured to the spacer S by conventional techniques such as a weld to provide an annular seal between the spacer S and the outer conduit wall 22o.

The conduit 24 also has a double-wall construction. For example, conduit 24 includes an inner conduit wall 24i surrounded by an outer conduit wall 24o. An annular insulating space 25 is defined between the conduit walls 24i, 24o. The insulating space 25 can be filled with only air, or can be filled with an insulating material such as fiberglass, ceramic fiber or other materials have effective thermal insulating properties. The ends of the inner conduit wall 24i define integral/unitary spacers S of the type described with respect to the conduit 22. The ends of the outer conduit wall 24o define integral/unitary flanges F2 and F1. The spacers S maintain the annular insulating space 25 between the conduit walls 24i, 24o, and provide a mechanical connection between the conduit walls 24i, 24o.

The conduit 26 further has a double-wall construction. For example, conduit 26 includes an inner conduit wall 26i surrounded by an outer conduit wall 26o. An annular insulating space 27 is defined between the conduit walls 26i, 26o. The insulating space 27 can be filled with only air, or can be filled with an insulating material such as fiberglass, ceramic fiber or other materials have effective thermal insulating properties. The upstream end of the inner conduit wall 26i defines an integral/unitary spacer S of the type described with respect to the conduit 22. The upstream end of the outer conduit 26o defines an integral/unitary flange F2. The spacer S maintains the annular insulating space 27 between the conduit walls 26i, 26o, and provides a mechanical connection between the conduit walls 26i, 26o. The diameter reducer 71 is secured to the downstream ends of the conduit walls 26i, 26o. The diameter reducer 71 includes a double wall construction including spaced-apart, truncated conical inner and outer walls 71i, 71o. The outer wall 71o is secured to the downstream end of the outer conduit wall 26o. The inner wall 71i is secured to the downstream end of the inner conduit wall 26i. The flanged end 70 is mounted at the downstream end of the diameter reducer 71.

A control system of the type described at PCT Patent Application Serial No. US04/18536, filed Jun. 10, 2004 and entitled “Method of Dispensing Fuel Into Transient Flow of an Exhaust System”, which is hereby incorporated by reference in its entirety, can be used to control regeneration of the aftertreatment device 28. Sensors of the control system can be mounted to the exhaust aftertreatment component. For example, a temperature sensor can be mounted in hole 500 of the conduit 22, pressure and temperature sensors can be mounted in holes 503, 504 of the conduit 22, and further pressure and temperature sensors can be mounted in holes 506, 508 of the conduit 26. The sensors can be secured/fastened to the outer walls of the conduits, and include portions that project inwardly through the double walls of the conduits.

An exhaust gas flow path extends axially through the center of the exhaust system component through the inlet section (i.e., conduit 22), through the intermediate section (i.e., conduit 24), and through the outlet section (i.e., conduit 26). Flow through the inlet section travels through the diesel oxidation catalyst 62, and flow through the intermediate section travels through the DPF. The insulating spaces 23, 25 and 27 are preferably generally isolated from the interior exhaust flow path of the exhaust system component (e.g., generally not in fluid communication with the interior of the exhaust system component). Although the spaces 23, 25 and 27 are generally isolated from the main exhaust gas flow path, a small amount of exhaust gas flow may occur between the main exhaust gas flow path and the spaces 23, 25 and 27. For example, openings 500-508 may allow relatively small amounts of exhaust gases to enter spaces 23 and 27. The insulating spaces preferably provide an effective buffer between the high temperature exhaust gas within the component and the exterior of the component. The insulating spaces 23, 25 and 27 are also generally isolated from one another.

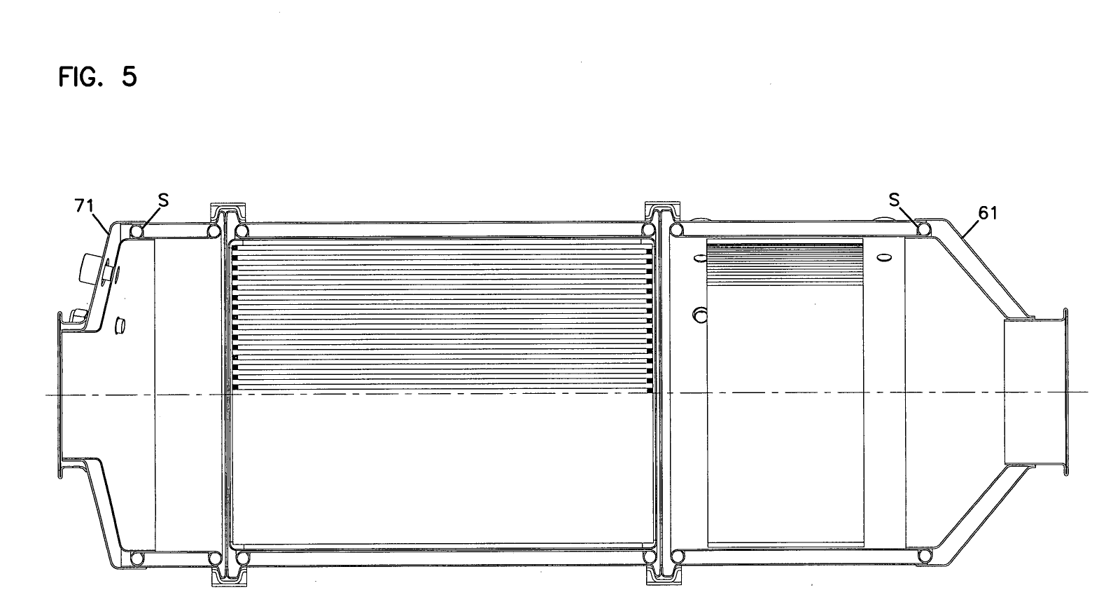

In other embodiments, spacers S can also be provided adjacent the diameter expander 61 and the diameter reducer 71 to provide further reinforcement (see FIG. 5).

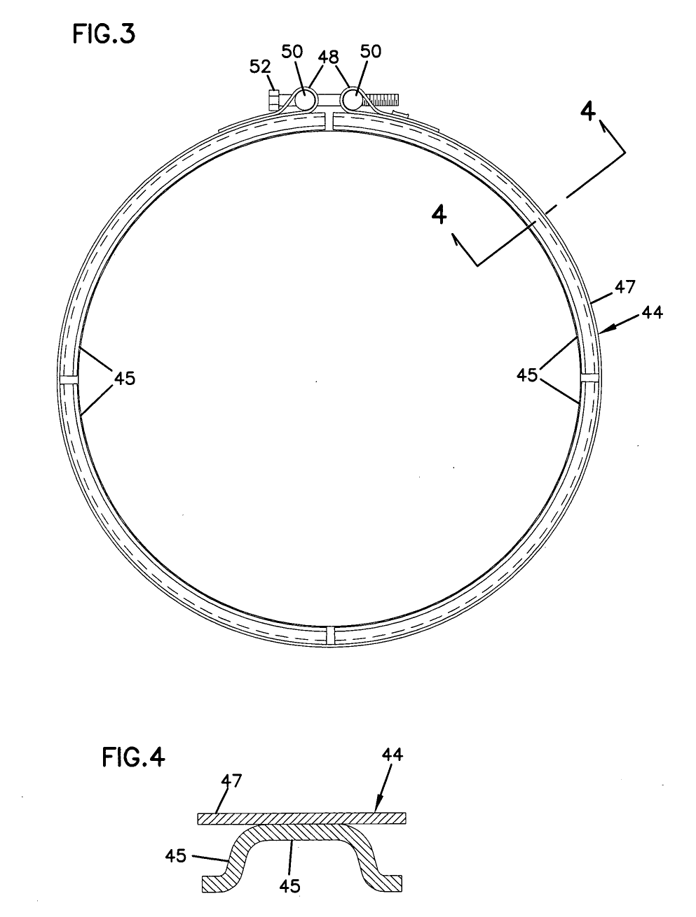

The clamps 44 are preferably v-band clamps which define v-shaped channels 45 adapted to fit over the exterior of the flange interfaces 38. FIGS. 3 and 4 show an example clamp 44 in isolation from the exhaust system component. The clamp 44 includes channel segments 45 secured to a strap 47. Ends 48 of the strap 47 are looped. Trunions 50 are mounted within the looped ends of the strap 47. One or more fasteners 52 extend between the trunions for tightening and loosening the clamp 44. By tightening the fasteners, the diameter of the clamp constricts. As used herein, the phrase “a channel” is intended to include a single channel and also to include more than one channel.

In one embodiment, a multi-layer insulation configuration can be used within the insulating spaces 23, 25, 27 or at any other space/location in an exhaust system where insulation is desired. The configuration preferably uses multiple concentric layers of insulation within the insulating space to provide low outer skin temperatures while maintaining relatively small thicknesses. In one example embodiment, the insulation technique allows relatively low outer skin temperatures (e.g., less than 120 degrees Celsius) while the internal exhaust temperatures are relatively high (e.g., 650 degrees Celsius or above). In certain embodiments, the configuration provides the above identified thermal gradient (i.e., 650 degrees Celsius to 120 degrees Celsius) while occupying a limited amount of space (e.g., a radial thickness less than or equal to 0.5 inches).

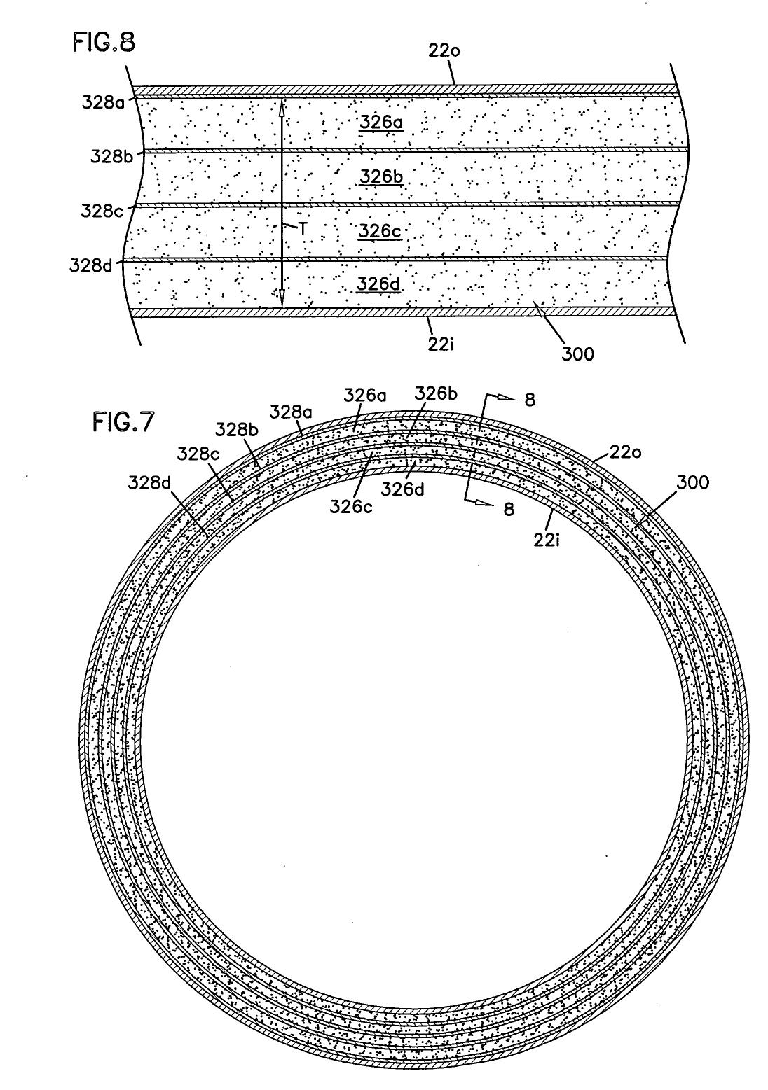

FIGS. 7 and 8 show an example multi-layer insulation configuration 300 positioned within the space 23 between inner and outer walls/skins 22i and 22o. The insulation configuration includes four insulation layers 326a, 326b, 326c and 326d. Foil layers 328a-328d are used to separate the layers of insulation. Foil layer 328a is positioned between the outer muffler wall 22o and insulation layer 326a. Foil layer 328b is positioned between insulation layer 326a and insulation layer 326b. Foil layer 326c is positioned between insulation layer 326b and insulation layer 326c. Foil layer 328d is positioned between insulation layer 326c and insulation layer 326d.

The layers 328a-328d are preferably metal foil (e.g., polished aluminum). In one embodiment, foil layers are about 2 to 3 mils in thickness. While metal foil is preferred, any high temperature resistant material that is capable of separating (i.e., dividing) the layers of insulation and has dissimilar material properties as compared to the layers of insulation can be used. The separating layers preferably provide a thermal boundary effect to improve the overall insulation capability of the arrangement. It is preferred for the divider layers to have a different (e.g., higher) thermal emissivity than the insulation layers so that the divider layers are better radiant heat reflectors than the insulation layers.

The insulation layers 326a-326d can be any number of different types of materials. Example materials include fiberglass, ceramic paper, ceramic mat or other materials. It is preferred for the overall thickness T of the insulating gap between the inner and outer walls 22i, 22o to be equal to or less than 0.5 inches. While four insulation layers have been depicted, it will be appreciated that more or fewer than four layers can be utilized depending upon the thermal gradient desired. In certain embodiments, the insulation layers can include only air without any additional materials (e.g., fiberglass, ceramic paper, ceramic mat, or other materials).

As described above, the aftertreatment device 28 is identified as a diesel particulate filter. However, it will be appreciated that double wall configurations in accordance with the principles of the present disclosure can be used in combination with a variety of aftertreatment devices. Example aftertreatment devices include catalytic converters, diesel particulate filters, lean NOx catalyst devices, selective catalytic reduction (SCR) catalyst devices, lean NOx traps, or other devices for removing for removing pollutants from the exhaust stream.

Catalytic converters are commonly used to convert carbon monoxides and hydrocarbons in the exhaust stream into carbon dioxide and water. Diesel particulate filters are used to remove particulate matter (e.g., carbon based particulate matter such as soot) from an exhaust stream. Lean NOx catalysts are catalysts capable of converting NOx to nitrogen and oxygen in an oxygen rich environment with the assistance of low levels of hydrocarbons. For diesel engines, hydrocarbon emissions are too low to provide adequate NOx conversion, thus hydrocarbons are required to be injected into the exhaust stream upstream of the lean NOx catalysts. SCR's are also capable of converting NOx to nitrogen and oxygen. However, in contrast to using HC's for conversion, SCR's use reductants such as urea or ammonia that are injected into the exhaust stream upstream of the SCR's. NOx traps use a material such as barium oxide to absorb NOx during lean bum operating conditions. During fuel rich operations, the NOx is desorbed and converted to nitrogen and oxygen by catalysts (e.g., precious metals) within the traps.

Diesel particulate filter substrates can have a variety of known configurations. An exemplary configuration includes a monolith ceramic substrate having a “honey-comb” configuration of plugged passages as described in U.S. Pat. No. 4,851,015 that is hereby incorporated by reference in its entirety. Wire mesh configurations can also be used. In certain embodiments, the substrate can include a catalyst. Exemplary catalysts include precious metals such as platinum, palladium and rhodium, and other types of components such as base metals or zeolites.

For certain embodiments, diesel particulate filters can have a particulate mass reduction efficiency greater than 75%. In other embodiments, diesel particulate filters can have a particulate mass reduction efficiency greater than 85%. In still other embodiments, diesel particulate filters can have a particulate mass reduction efficiency equal to or greater than 90%. For purposes of this specification, the particulate mass reduction efficiency is determined by subtracting the particulate mass that enters the filter from the particulate mass that exits the filter, and by dividing the difference by the particulate mass that enters the filter.

Catalytic converter substrates can also have a variety of known configurations. Exemplary configurations include substrates defining channels that extend completely therethrough. Exemplary catalytic converter configurations having both corrugated metal and porous ceramic substrates/cores are described in U.S. Pat. No. 5,355,973, that is hereby incorporated by reference in its entirety. The substrates preferably include a catalyst. For example, the substrate can be made of a catalyst, impregnated with a catalyst or coated with a catalyst. Exemplary catalysts include precious metals such as platinum, palladium and rhodium, and other types of components such as base metals or zeolites.

In one non-limiting embodiment, a catalytic converter can have a cell density of at least 200 cells per square inch, or in the range of 200-400 cells per square inch. A preferred catalyst for a catalytic converter is platinum with a loading level greater than 30 grams/cubic foot of substrate. In other embodiments the precious metal loading level is in the range of 30-100 grams/cubic foot of substrate. In certain embodiments, the catalytic converter can be sized such that in use, the catalytic converter has a space velocity (volumetric flow rate through the DOC/ volume of DOC) less than 150,000/hour or in the range of 50,000-150,000/hour. It will be appreciated that the above cell densities, catalyst loading levels, catalyst types and space velocities are merely examples, and that cell densities, catalyst loading levels, catalyst types and space velocities other than those specified can also be used.

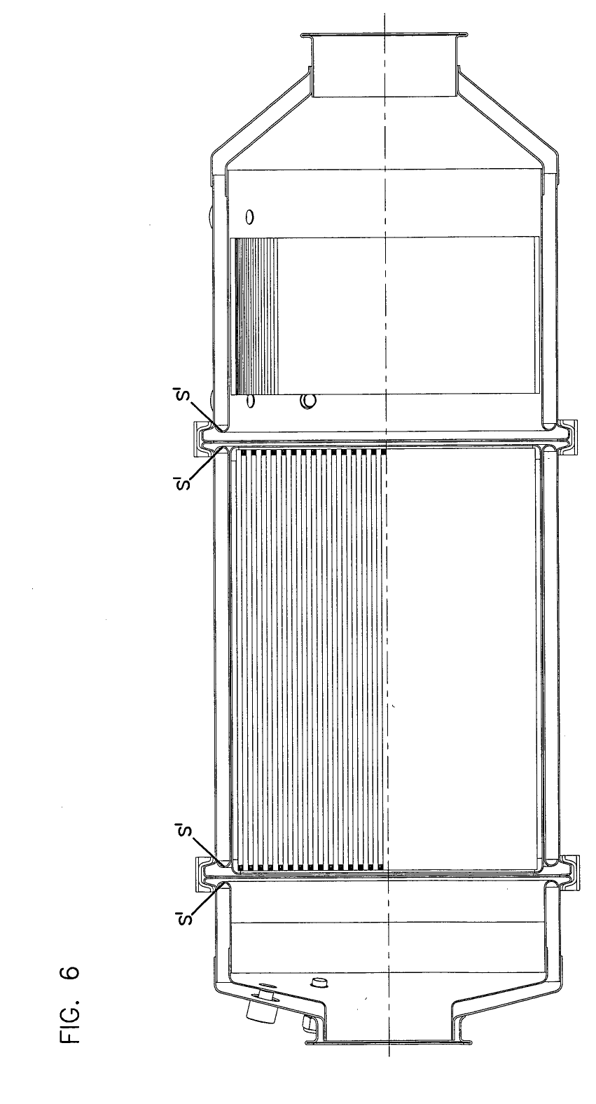

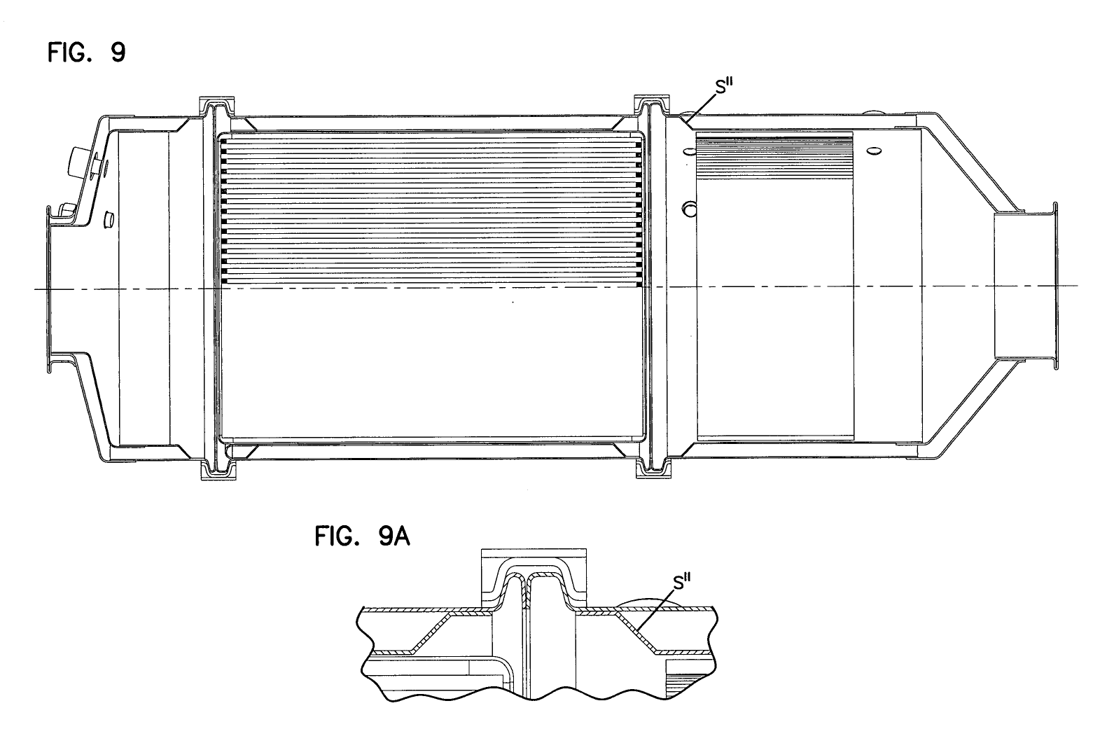

In the depicted embodiments, v-band clamps are used to hold the component sections together. It will be appreciated that in other embodiments, any number of different types of pipe clamps or fasteners could be used to fasten the parts together. Additionally, spacers in accordance with the present disclosure can also be used on exhaust treatment devices that are not configured for ready disassembly. Moreover, while the spacers S have been shown curled/rolled back approximately 360 degrees, in other embodiments the spacers could be curled less than 360 degrees. For example, FIG. 6 shows an exhaust system arrangement that is the same as the system of FIG. 1 except spacers S′ are curled less than 360 degrees (e.g., about 180 degrees). In still other embodiments, the spacers can include straight portions that extend between the inner and outer conduits. Other spacer shapes can include oval, elliptical, obround, semi-circular, rectangular, triangular, L-shaped, as well as other shapes. FIG. 9 shows a spacer S″ with a truncated conical portion angled relative to the longitudinal axis of the exhaust system component, and an end portion parallel to the longitudinal axis. The end portion can be secured (e.g., welded, bonded, fastened) to the outer wall of the exhaust system component. Furthermore, in certain embodiments, the spacers can be integral with either the inner or outer conduit. In certain embodiments, non-integral spacers or non-integral flanges may be used.

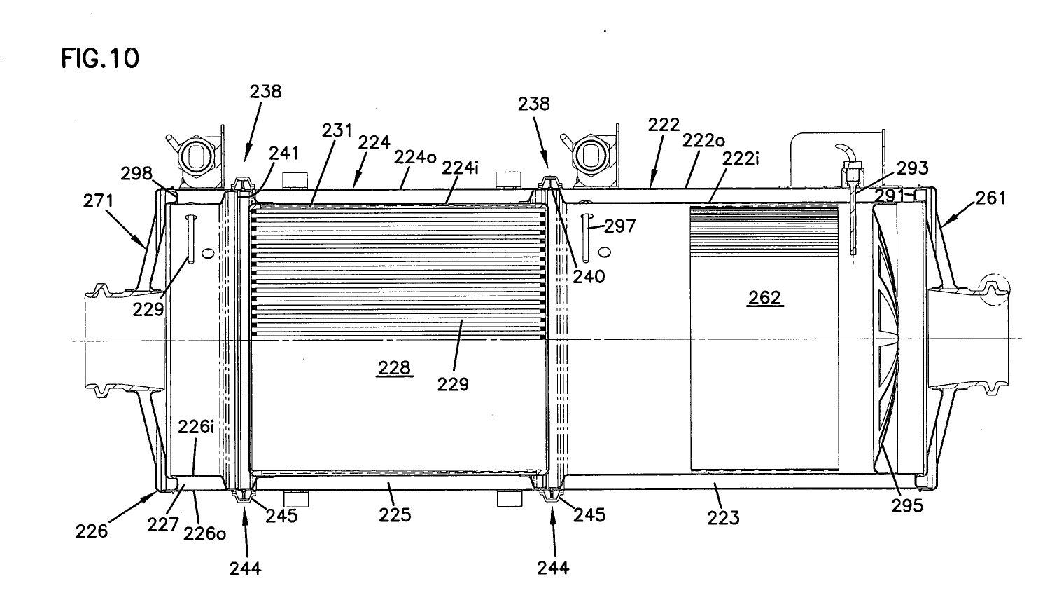

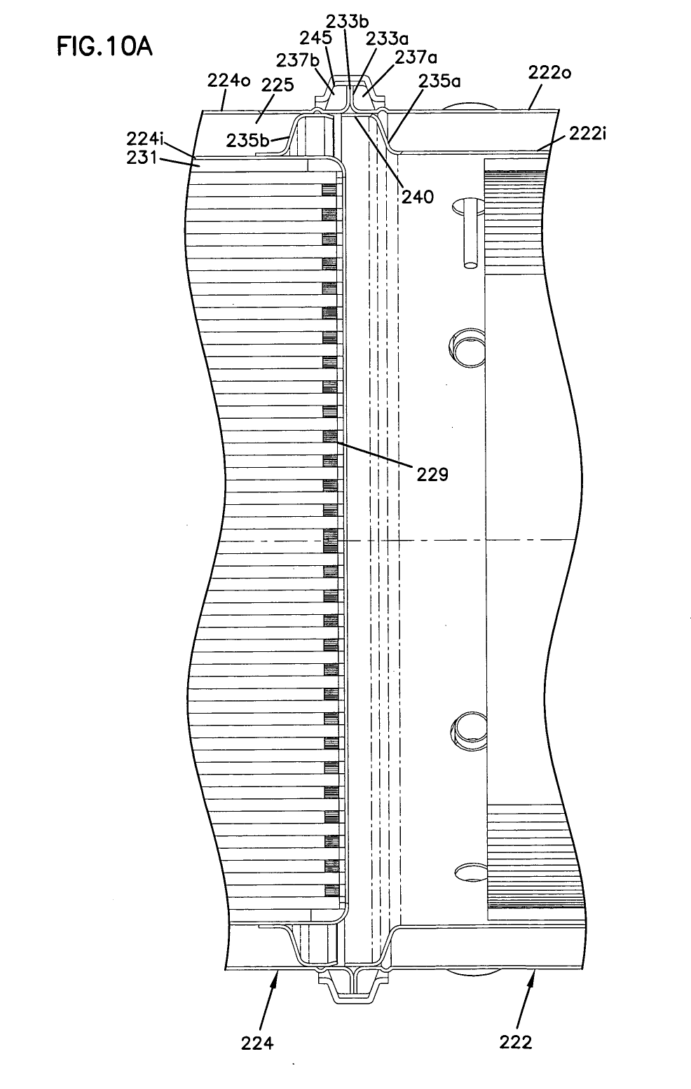

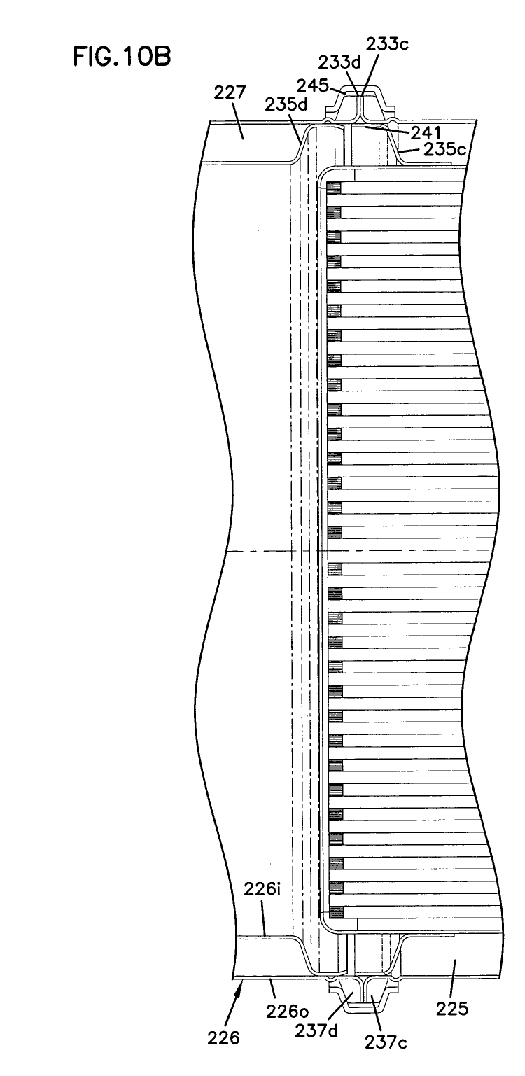

FIGS. 10, 10A and 10B show a generally cylindrical exhaust aftertreatment component 220 including an inlet section 222, an outlet section 226 and an intermediate section 224. A diesel particulate filter 228 is mounted within the intermediate section 224 and a diesel oxidation catalyst 262 (e.g., a catalytic converter) is mounted in the inlet section 222. A first access joint 238 is positioned between the inlet section 222 and the intermediate section 224, and a second access joint 238 is positioned between the outlet section 226 and the intermediate section 224. The joints 238 allow the diesel particulate filter 228 to be easily accessed for servicing (e.g., cleaning). The intermediate section 224 includes a pilot portion 241 and the inlet section 222 includes pilot portion 240. The pilot portions 240, 241 are configured such that the intermediate section 224 can only be mounted in one direction between the inlet and outlet sections 222, 226. This prevents the intermediate section 224 from being mounted backwards within the component 220. If an operator attempts to mount the intermediate section 224 backwards, the pilot portions 240, 241 interfere with one another to prevent assembly.

The inlet section 222 has a double wall construction including an outer wall 222o and an inner wall 222i. An annular insulating space 223 is defined between the walls 222o and 222i. The insulating space 223 is generally isolated from exhaust flow and can include air or thermal insulating material (e.g., insulating materials of the type previously described above). A flange 233a (see FIG. 10A) is unitary/integral with the downstream end of the outer wall 222o. A spacer 235a is unitary/integral with the downstream end of the inner wall 222i. The pilot portion 240 is unitary/integral with the spacer 235a. A diameter expander 261 of the inlet section 222 has a double wall configuration. A spacer 291 is integral with the inner wall of the diameter expander. A temperature sensor 293 and a flow distribution structure 295 are positioned upstream from the diesel oxidation catalyst 262, and a temperature sensor 297 is positioned downstream from the diesel oxidation catalyst 262. The temperature sensors 293, 257 are mounted to the outer wall of the inlet section 222 and include portions that extend through openings in the inner and outer walls. One or more pressure sensors can also be mounted to the inlet section 222.

The intermediate section 224 has a double wall construction including an outer wall 224o and an inner wall 224i. An annular insulating space 225 is defined between the walls 224o and 224i. The insulating space 225 is generally isolated from exhaust flow and can include air or thermal insulating material (e.g., insulating materials of the type previously described above). Flanges 233b, 233c are unitary/integral with the downstream and upstream ends of the outer wall 222o. Spacers 235b, 235c space the inner and outer walls from 224i, 224o from one another. The spacers 235b, 235c are not integral with the inner wall 224i, but are instead ring shaped pieces secured (e.g., welded, press-fit, fastened, etc.) about the exterior of the inner wall 224i. The inner wall 224i forms a can (e.g., a canister or housing) about a substrate 229 of the DPF 228. A cushioning mat 231 is provided directly between the inner wall 224i and the substrate 229. The ends of the inner wall 224i are bent inwardly to assist in retaining the substrate 229 within the inner wall 224i. The pilot portion 240 is unitary/integral with the spacer 235c.

The outlet section 226 has a double wall construction including an outer wall 226o and an inner wall 226i. An annular insulating space 227 is defined between the walls 226o and 226i. The insulating space 227 is generally isolated from exhaust flow and can include air or thermal insulating material (e.g., insulating materials of the type previously described above). A flange 233d is unitary/integral with the upstream end of the outer wall 226o. A spacer 235d is unitary/integral with the upstream end of the inner wall 226i. The outlet section 226 includes a diameter reducer 271 having a double wall configuration. A spacer 298 is integral with the inner wall of the diameter reducer 271. A temperature sensor 299 is mounted to the outer wall of the outlet section 226 and includes a portion that extends through openings in the inner and outer walls. One or more pressure sensors can also be mounted to the outlet section 226.

The access joints 238 are defined by the interfaces between the flanges 233a-233d. Clamps 244 (e.g., v-band clamps as depicted at FIGS. 3 and 4) having one or more channels 245 are used to mechanically couple the flanges 233a-233d at the access joints 238. The flanges 233a-233d are reinforced by collars 237a-237d mounted about the exterior of the muffler body. The collars are preferably generally ring-shaped. In certain embodiments, the collars are cast or machined steel parts. The collars 237a-237d define tapered clamping shoulders 239a-239d. In the depicted embodiment, the clamping shoulders 239a-239d are tapered to generally match the interior taper of the clamp channels 245. When assembled, the collars and the flanges of each joint with within the channel of a corresponding clamp. When the clamps are tightened, the diameters of the clamps constrict and the tapers of the clamp channels cause the flanges and the collars to be axially compressed together to secure and seal the access joints.

Flanges, spacers and insulation configurations in accordance with the principles of the present disclosure can be used in exhaust conduits, mufflers or any other exhaust system components adapted to house exhaust aftertreatment devices.

In the depicted embodiments, the outer walls of the inlet, intermediate and outlet sections define a primary outer boundary of the exhaust aftertreatment component (e.g., a cylindrical outer boundary), and the flanges project outwardly beyond the primary outer boundary. The flanges seal the outer walls of the exhaust system component sections relative to one another.

In a preferred embodiment, the outer walls are generally permanent structural parts of the exhaust aftertreatment components. “Generally permanent” means that outer walls are not intended to be removed from the inner walls, and that removal requires a portion of the exhaust aftertreatment component to be broken. In the depicted embodiments, at least portions of the inner and outer walls are welded together.

Other reinforcing collar configurations and flange configurations are disclosed in U.S. patent application Ser. No. ______, having Attorney Docket No. 758.1873USI1, entitled “Joint for an Engine Exhaust System Component”, that was filed on a date concurrent herewith, and that is hereby incorporated by reference in its entirety.

The above specification and examples provide a complete description of the manufacture and use of the invention. Since many embodiments of the invention can be made without departing from the spirit and scope of the invention, the invention resides in the claims hereinafter appended.

What is claimed is:

1. An exhaust system component comprising:
a component body including first and second sections, the component body defining an interior exhaust passage that extends though the first and second sections;
the first section including a first flange and the second section including a second flange;
a clamp for securing the first and second flanges together to form an access joint between the first and second sections, the clamp including a channel for receiving the first and second flanges;
the first section having an inner wall separated from an outer wall by an annular insulating space, the inner wall of the first section surrounding the exhaust passage of the component body; and
the second section having an inner wall separated from an outer wall by a annular insulating space, the inner wall of the second section surrounding the exhaust passage of the component body.

2. The exhaust component of claim 1, further comprising a spacer positioned between the inner and outer walls of the first section, the spacer being integral with one of the inner and outer walls of the first section.

3. The exhaust component of claim 2, wherein the spacer is integral with the inner wall of the first section, and the spacer is welded to the outer wall of the first section.

4. The exhaust component of claim 3, wherein a pilot portion is integral with the spacer.

5. The exhaust component of claim 3, wherein the first flange is integral with the outer wall of the first section.

6. The exhaust component of claim 5, wherein the first flange is reinforced by a collar mounted about an exterior of the outer wall of the first section.

7. The exhaust component of claim 1, further comprising spacers positioned between the inner and outer walls of the first and second sections, the spacers being integral with the inner or outer walls of the first and second sections.

8. The exhaust component of claim 7, wherein the spacers are integral with the inner walls of the first and second sections, and the spacers are welded to the outer walls of the first and second sections.

9. The exhaust component of claim 8, wherein the first flange is integral with the outer wall of the first section and the second flange is integral with the outer wall of the second section.

10. The exhaust component of claim 9, wherein the first flange is reinforced by a first collar mounted about an exterior of the outer wall of the first section, wherein the second flange is reinforced by a second collar mounted about an exterior of the outer wall of the second section, and wherein the first and second reinforcing collars as well as the first and second flanges are received within the channel of the clamp.

11. The exhaust system component of claim 2, wherein the spacer includes a curved, rolled back portion of one of the inner or outer walls.

12. The exhaust system component of claim 2, wherein the spacer is angled relative to a central axis of the exhaust system component.

13. The exhaust system component of claim 1, wherein the inner wall of the first section is generally permanently connected to the outer wall of the first section.

14. The exhaust system component of claim 1, wherein the outer walls of the first and second sections define a generally cylindrical outer boundary of the exhaust system component, and the first and second flanges project outwardly beyond the generally cylindrical outer boundary.

15. The exhaust system component of claim 1, wherein the annular insulating space of the first section is generally isolated from the annular insulating space of the second section.

16. An exhaust system component comprising:
a component body defining an inlet section, an outlet section, and an intermediate section mounted between the inlet and outlet sections, the intermediate section being connected to the inlet section by a first access joint and the intermediate section being connected to the outlet section by a second access joint, the component body also defining an interior exhaust passage that extends thought the inlet section, the intermediate section and the outlet section;
a diesel particulate filter mounted in the intermediate section of the component body and a diesel oxidation catalyst mounted in the inlet section of the component body;
the inlet section including an downstream flange at a downstream end of the inlet section, the outlet section including an upstream flange at an upstream end of the outlet section, and the intermediate section including upstream and downstream flanges at upstream and downstream ends of the intermediate section;
the first access joint being secured by a first channel clamp that receives the downstream flange of the inlet section and the upstream flange of the intermediate section;
the second access joint being secured by a second channel clamp that receives the upstream flange of the inlet section and the downstream flange of the intermediate section;
the inlet section having an inner wall separated from an outer wall by an annular insulating space, the inner wall of the inlet section surrounding the exhaust passage of the component body, the diesel oxidation catalyst being mounted inside the inner wall of the inlet section;
the outlet section having an inner wall separated from an outer wall by a annular insulating space, the inner wall of the outlet section surrounding the exhaust passage of the component body;
the intermediate section having an inner wall separated from an outer wall by an annular insulating space, the inner wall of the intermediate section surrounding the exhaust passage of the component body, the diesel particulate filter being mounted inside the inner wall of the intermediate section;
the annular insulating space of the intermediate section being generally isolated from the annular insulating spaces of the inlet and outlet sections;
the downstream flange of the inlet section being unitary with the outer wall of the inlet section;
the upstream and downstream flanges of the intermediate section being unitary with the outer wall of the intermediate section; and
the upstream flange of the outlet section being unitary with the outer wall of the outlet section.

17. The exhaust system component of claim 16, wherein the intermediate section has a unidirectional mounting configuration.

18. The exhaust system component of claim 16, wherein the inlet section includes a diameter expander having inner and outer expander walls that provide a diameter transition, wherein annular insulating space is defined between the inner and outer expander walls, wherein the outlet section includes a diameter reducer having inner and outer reducer walls that provide a diameter transition, and wherein annular insulating space is defined between the inner and outer reducer walls.

19. The exhaust system component of claim 16, further comprising a first reinforcing collar mounted about the inlet section for reinforcing the downstream flange of the inlet section, a second reinforcing collar mounted about the intermediate section for reinforcing the upstream flange of the intermediate section, a third reinforcing collar mounted about the intermediate section for reinforcing the downstream flange of the intermediate section, and a fourth reinforcing collar mounted about the outlet section for reinforcing the upstream flange of the outlet section, the first and second reinforcing collars being received within the first channel clamp and the third and fourth reinforcing collars being received within the second channel clamp.

20. The exhaust system component of claim 16, wherein the inlet section includes a spacer unitary with the inner wall of the inlet section for maintaining the annular insulating space of the inlet section, and the outlet section includes a spacer unitary with the inner wall of the outlet section for maintaining the annular insulating space of the outlet section.

21. The exhaust system component of claim 19, wherein the first and second reinforcing collars have taper surfaces that are angled to match a taper of the first channel clamp, and the second and third reinforcing collars have taper surfaces that are angled to match a taper of the second channel clamp.

22. An apparatus for conveying exhaust, the apparatus comprising:
an inner cylindrical conduit wall;
an outer cylindrical conduit wall that surrounds the inner cylindrical conduit wall;
an annular insulating gap defined between the inner and outer cylindrical conduit walls;
a spacer that maintains the gap between the inner and outer cylindrical conduit walls, the spacer being integral with respect to at least one of the first and second cylindrical conduit walls.

23. An exhaust system conduit comprising:
an inner conduit wall and an outer conduit wall defining an insulating space thereinbetween, an inner surface of the inner conduit wall defining an interior exhaust flow passage, the insulating space being isolated from the exhaust flow passage; and
a divider arrangement positioned within the insulating space, the divider arrangement including at least a first dividing layer that divides the insulating space into first and second chambers, the first chamber being positioned inside the first dividing layer and the second chamber being positioned outside the first dividing layer.

24. The exhaust system conduit of claim 23, wherein the first and second chambers contain include air as an insulating medium.

25. The exhaust system conduit of claim 23, wherein insulating material is positioned within the first and second chambers.

26. The exhaust system conduit of claim 25, wherein the insulating material is fibrous.

27. The exhaust system conduit of claim 23, wherein the divider layer includes a metal foil layer

28. The exhaust system component of claim 23, further comprising a second dividing layer positioned outside the second chamber and a third chamber positioned between the second dividing layer and the outer conduit wall.
